(19) United States
(12) Patent Application Publication
(10) Pub. No.: US 2013/0328899 A1
(43) Pub. Date: Dec. 12, 2013

(54) RENDERING DEVICE, RENDERING METHOD AND RECORDING MEDIUM

(71) Applicants: Masanori Nakata, Tokyo (JP); Noriyuki Kushiro, Tokyo (JP); Makoto Katsukura, Tokyo (JP); Yoshiaki Koizumi, Tokyo (JP)

(72) Inventors: Masanori Nakata, Tokyo (JP); Noriyuki Kushiro, Tokyo (JP); Makoto Katsukura, Tokyo (JP); Yoshiaki Koizumi, Tokyo (JP)

(73) Assignee: MITSUBISHI ELECTRIC CORPORATION, Tokyo (JP)

(21) Appl. No.: 13/882,557

(22) PCT Filed: Jan. 27, 2011
(86) PCT No.: PCT/JP2011/051660

§ 371 Date: Jul. 5, 2013

(30) Foreign Application Priority Data
Nov. 1, 2010 (JP) 2010-245707

(51) Int. Cl. G06T 1/60

(52) U.S. Cl. CPC G06T 1/60
USPC 345/564

(57) ABSTRACT

A DMA controller reads image information recorded on a ROM by address unit from a front reading start position. A shift operator shifts a first data sequence of one row of the reading by only a designated number of bits, and generates a second data sequence. A DMA controller reads a third data sequence already stored in a VRAM writing start position. A controller performs a prescribed operation on the second data sequence and the third data sequence, and generates a fourth data sequence. The controller writes the generated fourth data sequence successively in a horizontal direction by address unit from the VRAM writing start position.

### TECHNICAL FIELD

The present invention relates to a rendering device and rendering method for rendering an image on a full-dot liquid crystal screen of a remote controller and/or the like used in remote operation of an air conditioning device, a lighting device and/or the like.

### BACKGROUND ART

Conventionally, a seven-segment type of simple display has been used for the display screens of remote controllers used in remote operation of an air conditioning device, a lighting device and/or the like. However, recently a growing number are equipped with a full-dot liquid crystal display screen (for example, see Patent Literature 1).

### CITATION LIST

### Patent Literature

[PTL 1] Unexamined Japanese Patent Application Kokai Publication No. 2010-175786.

### SUMMARY OF INVENTION

### Technical Problem

When displaying two-dimensional images such as a character on a full-dot liquid crystal display screen, a bit map image such as a character and/or the like is transferred from a ROM (Read Only Memory) to a VRAM (Video Random Access Memory). This transfer is accomplished by address unit (for example, 8-bit unit).

Consequently, there was an inconvenience in that the image such as a character could only be arranged in an 8-bit space on the VRAM, and through this the freedom of display was limited. In addition, when the attempt was made to display an image such as a character at a central position in the 8-bit space, the inconvenience arose that a portion of a different image already displayed was erased.

In consideration of the foregoing, it is an objective of the present invention to provide a rendering device and rendering method that can improve the freedom of display in a full-dot liquid crystal display screen.

### Solution to Problem

In order to achieve the above objective, the rendering device according to the present invention reads in address units image information stored in a memory medium in which each row of a data sequence is linked in sequential order, and displays an image based on this image information by writing in a prescribed region of a two-dimensional image display memory. In this rendering device, a first reader reads the image information stored in the memory medium in address units from a reading start address that is the lead thereof. A shift operator generates a second data sequence by shifting a first data sequence that is one row of data in the image information read by the first reader by a specified number of bits. A second reader reads a third data sequence already stored at a writing start position of the image display memory. An operator generates a fourth data sequence by performing a prescribed operation using the second data sequence shifted by the shift operator and the third data sequence read by the second reader. A writer successively writes the fourth data sequence generated by the operator in a horizontal direction in the address units beginning from the writing start position of the image display memory. A writing position updater updates the writing start position in the image display memory to a position in the same column of the next row each time writing of each row of the data sequence by the writer concludes.

### Advantageous Effects of Invention

With the present invention, it is possible to shift each row of image data read from a memory medium by a designated number of bits and to integrate such with surrounding images already displayed, so it is possible to cause a character to be displayed at an arbitrary position and it is also possible to prevent erasure of surrounding images that are already displayed. As a result, it is possible to improve freedom of display on a full-dot liquid crystal display screen.

### BRIEF DESCRIPTION OF DRAWINGS

FIG. 1 is a block diagram showing the composition of a rendering device according to a preferred embodiment of the present invention;

FIG. 2A is a rendering showing one example of a bit map image for a character;

FIG. 2B is a rendering schematically showing the state in which data of a bit-map image of the character of FIG. 2A is stored in a ROM;

FIG. 3 is a block diagram showing the composition of the DMA controller of FIG. 1;

FIG. 4A is a rendering for explaining a first transfer mode in the DMA controller of FIG. 3;

FIG. 4B is a rendering for explaining a second transfer mode in the DMA controller of FIG. 3;

FIG. 4C is a rendering for explaining a third transfer mode in the DMA controller of FIG. 3;

FIG. 5 is a rendering for explaining a memory map of the VRAM of FIG. 1;

FIG. 6 is a rendering showing one example of a whole image displayed on the display screen of the display device of FIG. 1;

FIG. 7 is a block diagram for explaining the composition of the companion chip of FIG. 1, and the flow of signals;

FIG. 8A is a rendering showing one example (number one) of a process of the controller;

FIG. 8B is a rendering showing one example (number one) of an image displayed on the display device;

FIG. 9 is a rendering showing the process sequence of the rendering device of FIG. 1;

FIG. 10A is a rendering showing one example (number two) of a process of the controller;

FIG. 10B is a rendering showing one example (number two) of an image displayed on the display device;

FIG. 11A is a rendering showing one example (number three) of a process of the controller; and

FIG. 11B is a rendering showing one example (number three) of an image displayed on the display device.

### DESCRIPTION OF EMBODIMENTS

The preferred embodiment of the present invention is described in detail below with reference to the renderings;

The rendering device according to the preferred embodiment of the present invention is described below.

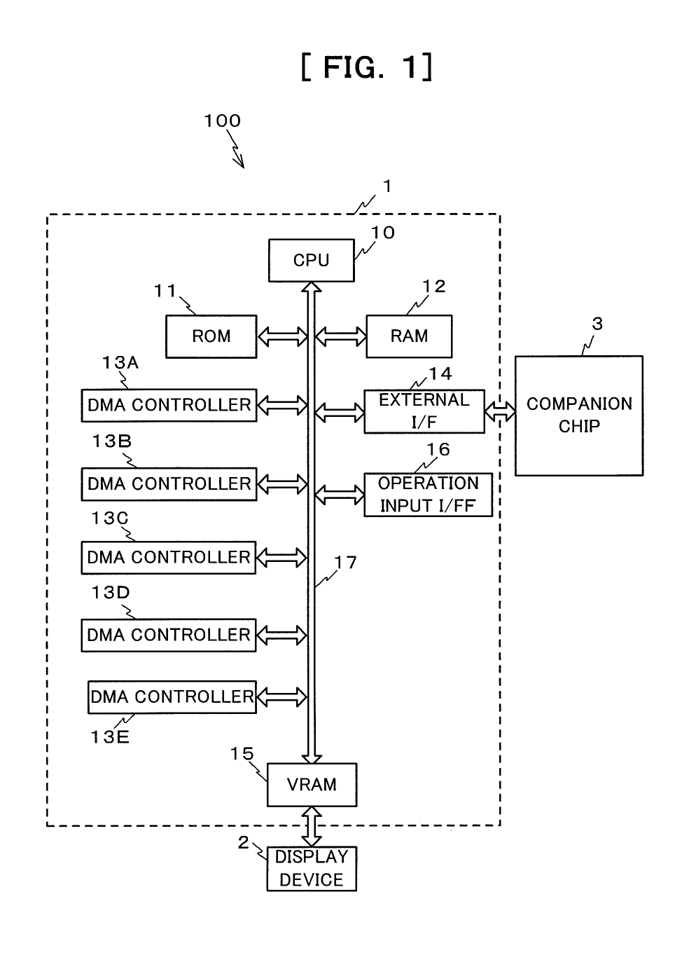

First, the composition of a rendering device 100 according to this preferred embodiment will be explained with reference to FIG. 1. This rendering device 100 is, for example, a remote controller for an unrepresented air conditioning device. As shown in FIG. 1, the rendering device 100 is provided with a microcomputer 1, a display device 2 and a companion chip 3.

The microcomputer 1 comprises a CPU 10; a ROM 11; a RAM (Random Access Memory) 12; DMA controllers 13A, 13B, 13C, 13D and 13E; an external interface (I/F) 14; a VRAM 15; and an operation input interface (I/F) 16. These are mutually connected via a bus 17 to enable receiving and transmitting of data.

As a processor, the CPU 10 controls the rendering device 100 as a whole. In addition, it would be fine for the CPU 10 to control not just the rendering device (remote controller) 100 but also the air conditioning device as a whole. In addition, it would be fine for the CPU 10 to accomplish cooperative control extending over multiple air conditioning devices.

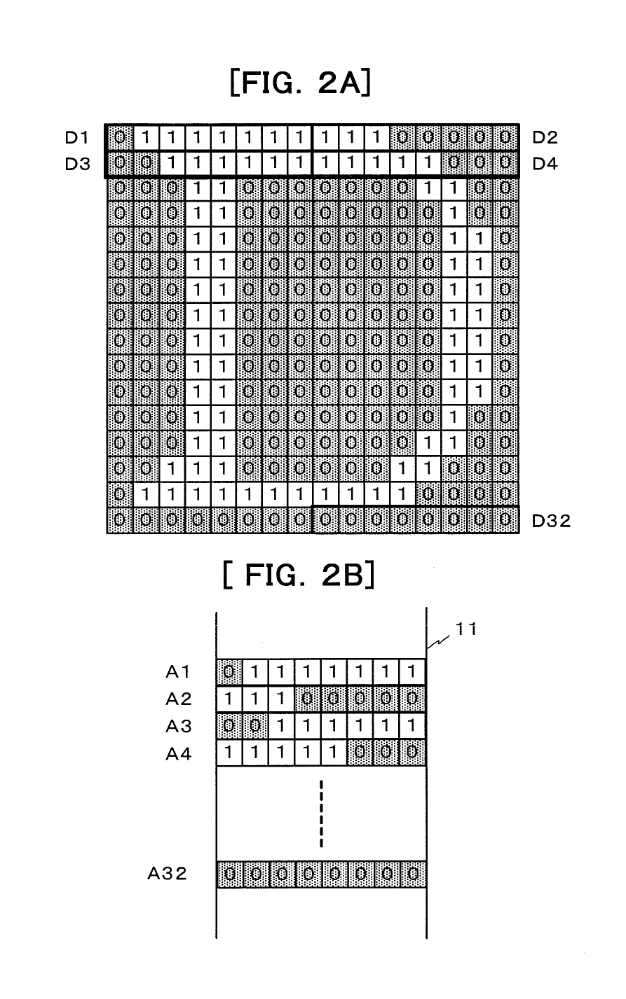

As a memory medium, the ROM 11 stores multiple items of displayed image data. Included in this kind of image data is image data such as characters and figures. In FIG. 2A, a bitmap image of the character “D” is displayed as one example of this kind of image. This bitmap image is a 16 bits×16 bits image. Supposing 1 byte to be 8 bits, the bitmap image contains a total of 32 bytes of data.

Here, suppose the 8 bits on the left side of the top row of the bitmap image is data D1, and the 8 bits on the right side of the top row is data D2. In addition, suppose the 8 bits on the left side of the next row is data D3 and the 8 bits on the right side of that row is data D4. Similarly, when the 8 bits on the left side and the 8 bits on the right side of each row are compiled, the 8 bits on the right side of the bottom row of the bitmap image becomes data D32.

The data of this bitmap image is stored in the ROM 11, as shown in FIG. 2B. As shown in FIG. 2B, the data D1 that is the 8 bits on the left side of the top row of the bitmap image is stored at an address A1. The data D2 is stored at the next address A2. Similarly, the data D3 that is the 8 bits on the left side of the next row is stored at an address A3, and the data D4 of the 8 bits on the right side is stored at an address A4. Furthermore, the data D32 that is the 8 bits on the right side of the bottom row is stored at a final address A32.

In this manner, the data sequence of each row of an image such as a character that should be displayed is linked in order in the ROM 11 and is stored in address order.

Data used by the CPU 10 is written as necessary in the RAM 12.

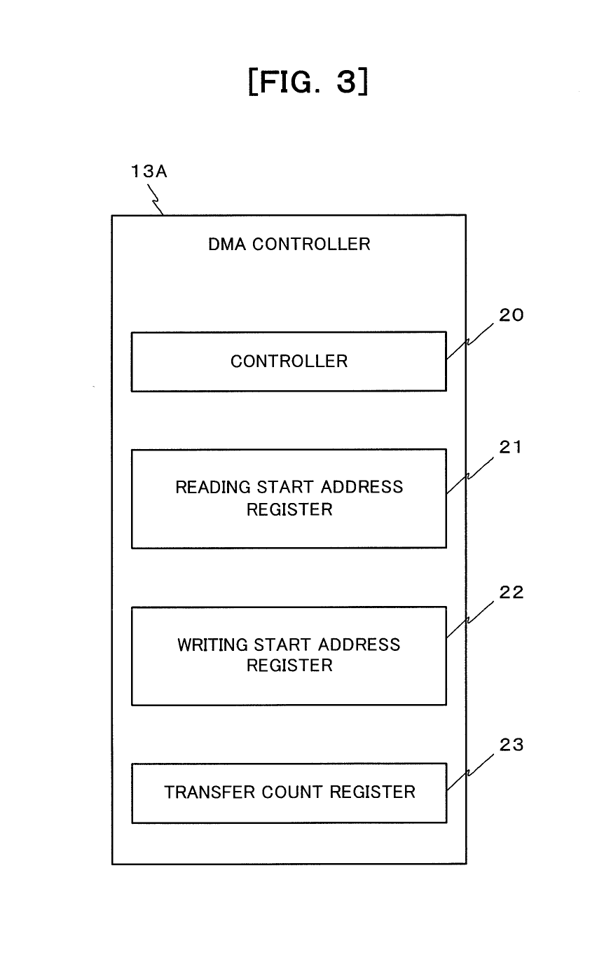

The DMA controllers 13A, 13B, 13C, 13D and 13E accomplish data transfer independent of the CPU 10. FIG. 3 shows the composition of the DMA controller 13A. As shown in FIG. 3, the DMA controller 13A comprises a controller 20, a reading start address register 21, a writing start address register 22 and a transfer count register 23.

The controller 20 transfers data to a transfer destination from a transfer source via the bus 17. The reading start address at the transfer source is set in the reading start address register 21. The writing start address at the transfer destination is set in the writing start address register 22. The number of times DMA transfer is accomplished is set in the transfer count register 23. Because the size of data transferred with one transfer is 1 byte, for example the transfer count when transferring 32 bytes of data is 32.

The controller 20 reads the data in address units (1 byte) from the reading start address set in the reading start address register 21. The controller 20 does a DMA transfer of the data from the transfer source to the transfer destination by successively writing the data starting at the writing start address stored in the writing start address register 22. DMA transfer ends with the transfer count stored in the transfer count register 23.

The compositions of the DMA controllers 13B, 13C, 13D and 13E are the same as the composition of the DMA controller 13A shown in FIG. 3. Below, the reading start address register 21, the writing start address register 22 and the transfer count register 23 are together called the register group.

It is possible for the DMA controllers 13A, 13B, 13C, 13D and 13E to accomplish data transfer in three transfer modes.

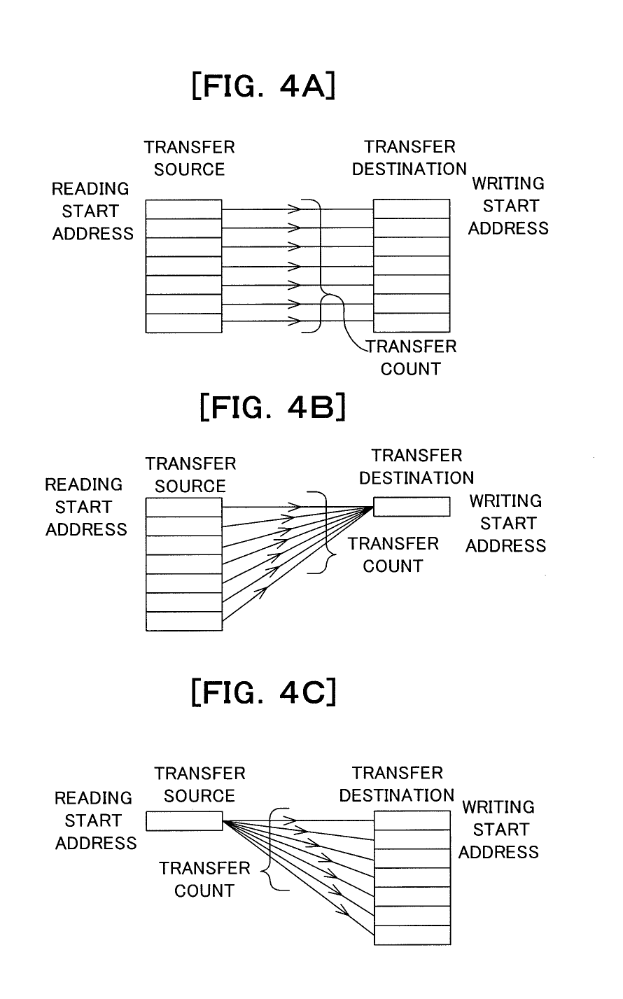

FIG. 4A schematically shows a first transfer mode. As shown in FIG. 4A, the first transfer mode is a transfer mode for shifting both the transfer source address and the transfer destination address each time 1 byte is written. With this first transfer mode, the data of the transfer source is copied without change to the transfer destination.

FIG. 4B schematically shows a second transfer mode. As shown in FIG. 4B, the second transfer mode is a transfer mode for fixing the transfer destination address. With this second transfer mode, the data of the transfer source is overwritten on the same address at the transfer destination (writing start address).

FIG. 4C schematically shows a third transfer mode. As shown in FIG. 4C, the third transfer mode is a transfer mode for fixing the address of the transfer source. With this third transfer mode, data from the transfer source written at the reading start address is written to multiple addresses at the transfer destination in a byte count corresponding to the transfer count, starting at the writing start address.

In this preferred embodiment, the DMA controller 13A acts under the second transfer mode. The DMA controller 13B acts under the third transfer mode. The DMA controllers 13C, 13D and 13E act under the first transfer mode.

The external I/F 14 is a communication interface for accomplishing data sending and receiving with external equipment. The companion chip 3 is connected to the external I/F 14. Through this, the companion chip 3 is able to send and receive data with the CPU 10; the ROM 11; the RAM 12; the DMA controllers 13A, 13B, 13C, 13D and 13E; the external I/F 14; and the VRAM 15.

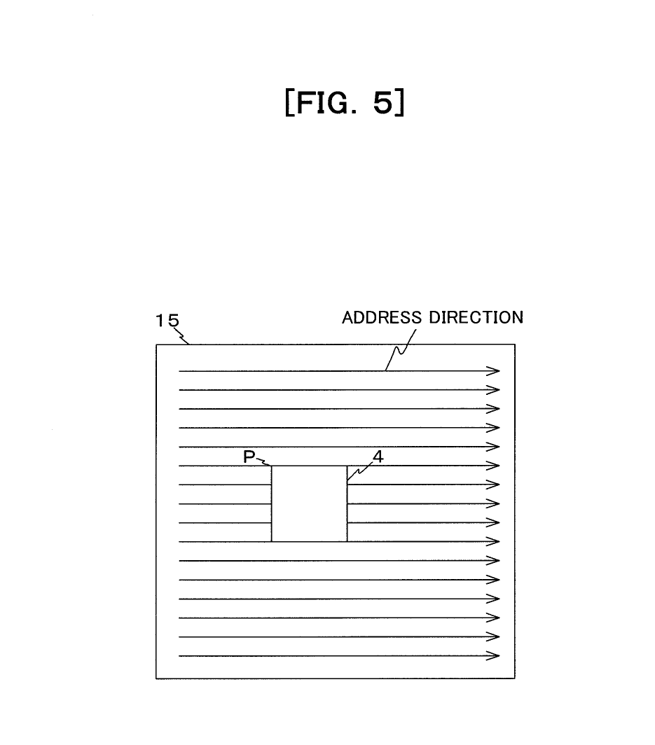

The VRAM 15 is memory for two-dimensional image displays. FIG. 5 schematically shows a memory map of the VRAM 15. As shown in FIG. 5, the direction of addresses in the VRAM 15 is a row direction (horizontal direction). The smallest address is at the top left edge of the VRAM 15, while the largest address is at the lower right edge.

When the attempt is made to write the image data 4 with a specific position P in the VRAM 15 as the standard, the image data 4 is written from the address corresponding to the specific position P. In this case, when the next row of the data sequence in the image data 4 is written, it is necessary to update the address at the transfer destination to an address in the same column as the writing start address of the next row, or to add an offset.

The operation input interface 16 is a man-machine interface having an operation input unit such as a button and/or the like that can be operated by a user.

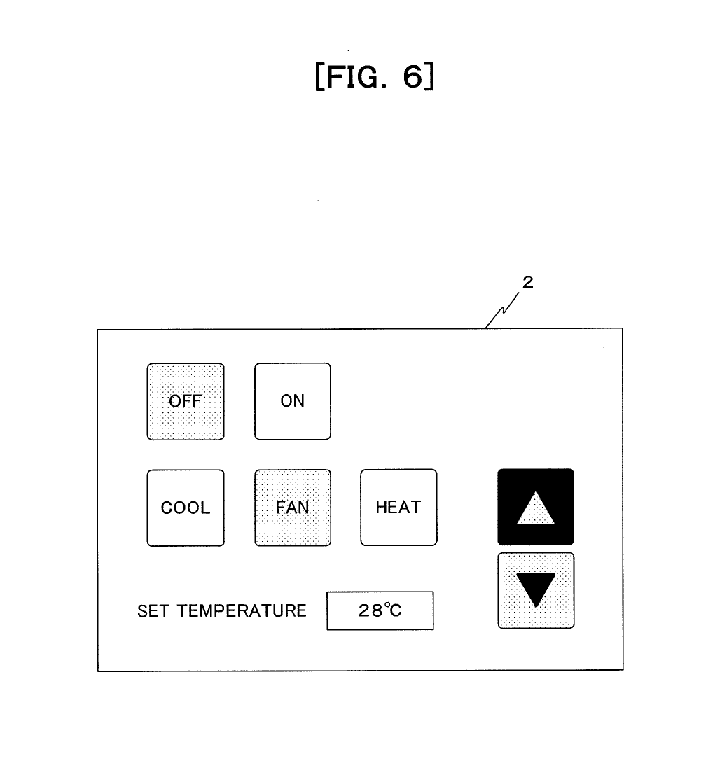

The display device 2 possesses a full-dot liquid crystal display screen. The size of this display screen is, for example, 120 through 240 dots vertically and 250 through 320 dots horizontally. When the image data is written on the VRAM 15, an image based on that image data is displayed on this display screen. FIG. 6 shows an example of a screen displayed on the display device 2. It would also be fine to provide a touch panel on the display screen.

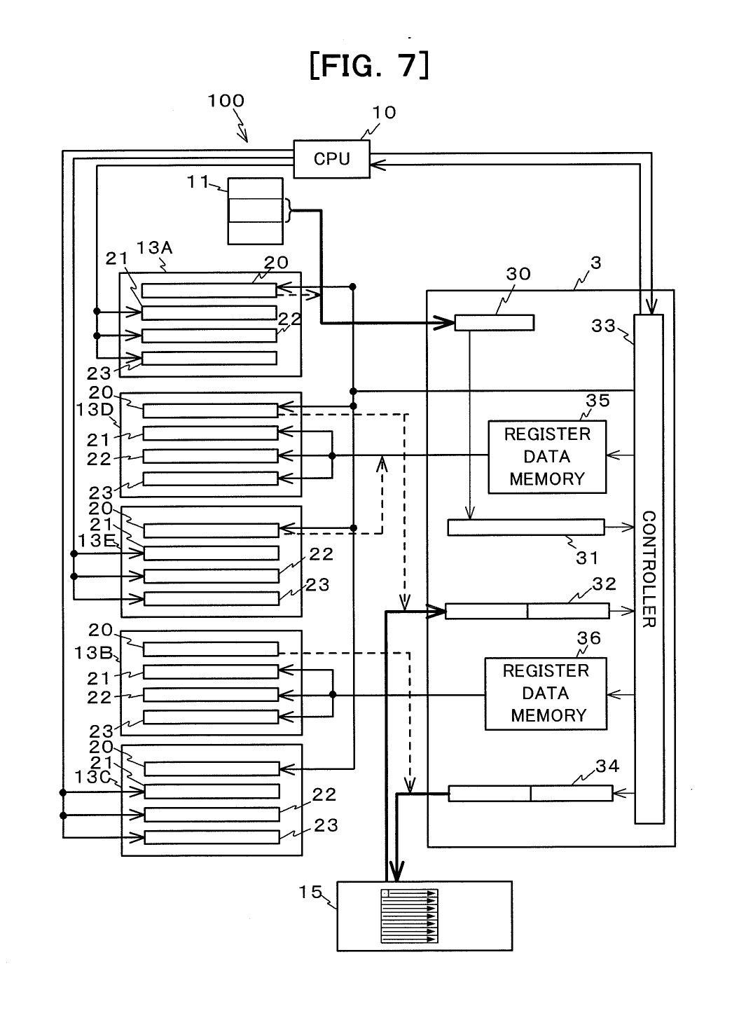

FIG. 7 shows the detailed composition of the companion chip 3. As shown in FIG. 7, the companion chip 3 comprises a buffer 30, a shift operator 31, a buffer 32, a controller 33, a buffer 34 and register data memories (RDM) 35 and 36.

The buffer 30 is a memory capable of holding a 1-byte data sequence (first data sequence), for example. The shift operator 31 shifts the data sequence (first data sequence) stored in the buffer 30 by a number of bits designated by the CPU 10 and stores the result as 2-bytes data (second data sequence).

On the other hand, the buffer 32 stores a 2-bytes data sequence (third data sequence) already stored at the writing start position of the VRAM 15.

The controller 33 controls DMA transfer in accordance with instructions from the CPU 10. Furthermore, the controller 33 uses the 2-bytes data sequence (second data sequence) shifted by the shift operator 31 and the 2-bytes data sequence (third data sequence) read from the buffer 32 to perform a prescribed operation and generate a data sequence (fourth data sequence) integrating these.

The data sequence (fourth data sequence) generated by the controller 33 is stored in the buffer 34. The controller 33 writes the data sequence stored in the buffer 34 in the VRAM 15.

The register data memory 35 is a memory for storing data set in the reading start address register 21, the writing start address register 22 and the transfer count register 23 of the DMA controller 13D. The register data memory 36 is a memory for storing data set in the reading start address register 21, the writing start address register 22 and the transfer count register 23 of the DMA controller 13B.

The composition of the companion chip 3 will be described in further detail.

1 byte of image data from the ROM 11 is DMA transferred to the buffer 30. This DMA transfer is executed by the DMA controller 13A.

Preceding this DMA transfer, the CPU 10 accomplishes setting of the register group of the DMA controller 13A. Through this setting, the leading address of the image data of the ROM 11 is set in the reading start address register 21 of the DMA controller 13A. In addition, the address of the buffer 30 of the companion chip 3 is set in the writing start address register 22. In addition, the number of bytes of the image information as a whole (that is to say, the transfer count necessary for transferring the image data in entirety) is set in the transfer count register 23.

The controller 33 of the companion chip 3 outputs a control signal to the controller 20 of the DMA controller 13A. When the controller 33 outputs the control signal for DMA transfer start, the controller 20 of the DMA controller 13A starts DMA transfer to the buffer 30 from the ROM 11.

On the other hand, 2 bytes of image data are DMA transferred to the buffer 32 starting at the writing start address of the VRAM 15. This DMA transfer is executed by the DMA controller 13D.

Preceding this DMA transfer, settings are made in the register group of the DMA controller 13D. Through these settings, the writing start address of the VRAM 15 is set in the reading start address register 21 of the DMA controller 13D. In addition, the address of the buffer 32 is set in the writing start address register 22. In addition, a byte count with 1 byte added to the byte count of one row of data sequence (here, 2 bytes) is set in the transfer count register 23. These register settings are accomplished as described below.

In the rendering device 100, the DMA controller 13E is provided for settings in the register group of the DMA controller 13D. With the DMA controller 13E, data set in the register group of the DMA controller 13D is DMA transferred to the register group of the DMA controller 13D from the register data memory 35 of the companion chip 3.

First, the CPU 10 accomplishes register settings for the DMA controller 13E. The address of the register memory 35 of the companion chip 3 is set in the reading start address register 21 of the DMA controller 13E. In addition, the address of the register group of the DMA controller 13D is set in the writing start address register 22. In addition, the byte count of the register group is set in the transfer count register 23.

The CPU 10 outputs to the controller 33 of the companion chip 3 the vertical and horizontal byte count in the image information read from the ROM 11, and the position of rendering that image on the VRAM 15 (the writing start address on the VRAM 15). The controller 33 sets in the register data memory 35 the writing start address on the VRAM 15, the address of the buffer 32 and 2 bytes.

The controller 33 outputs the control signal for starting DMA transfer to the controller 20 of the DMA controller 13E. Whereupon, the data contained in the register data memory 35 of the companion chip 3 is DMA transferred to the register group of the DMA controller 13D under control of the DMA controller 13E. As a result, the writing start address of the VRAM 15 is set in the reading start address register 21 of the DMA controller 13D. In addition, the address of the buffer 32 of the companion chip 3 is set in the writing start address register 22. In addition, the byte count (2) of the buffer 32 is set in the transfer count register 23.

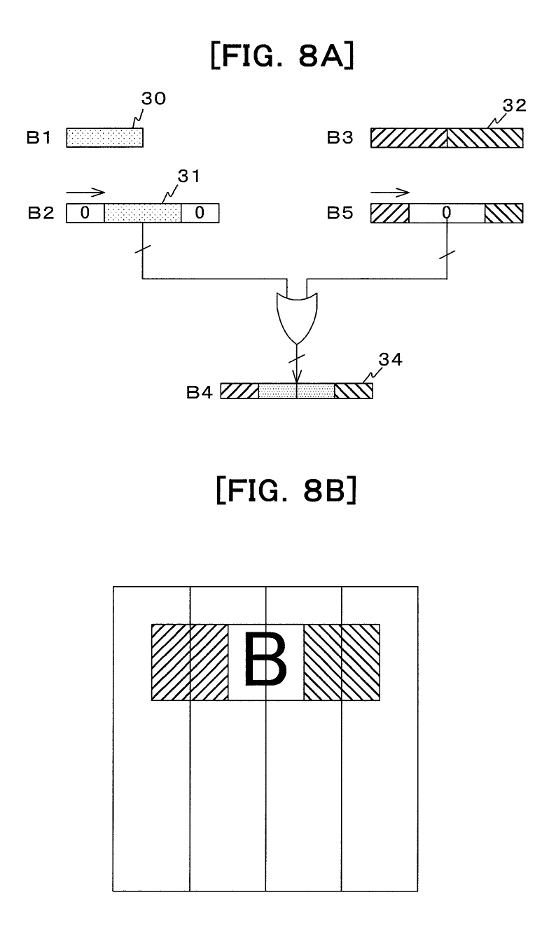

As shown in FIG. 8A, the data sequence read into the buffer 30 is a data sequence B1. Suppose the data sequence that is a 2-bytes data sequence including the data sequence B1 shifted by the shift operator 31 is a data sequence B2. In addition, suppose the 2-bytes data sequence read into the buffer 32 is a data sequence B3. The data sequences B2 and B3 are input into the controller 33. The controller 33 first generates a data sequence B5 by clearing to zero the value of the part of the data sequence B3 corresponding to the data sequence B1. Furthermore, the controller 33 generates as a data sequence B4 the logical sum of the data sequence B2 and the data sequence B5. This data sequence B4 is output to the buffer 34.

1 byte of image data DMA transferred to the buffer 34 is DMA transferred to the VRAM 15. This DMA transfer is executed by the DMA controller 13B.

Preceding the DMA transfer, setting of the register group in the DMA controller 13B is done. Through this setting, the address of the buffer 34 of the companion chip 3 is set in the reading start address register 21 of the DMA controller 13B. In addition, the writing start address of the VRAM 15 is set in the writing start address register 22. In addition, the byte count (for example, 2) found by adding one more byte to the byte count corresponding to the length of the data sequence of each row of the image information is set in the transfer count register 23. These register settings are accomplished as described below.

In the rendering device 100, the DMA controller 13C is provided for settings in the register group of the DMA controller 13B. With the DMA controller 13C, data set in the register group of the DMA controller 13B is DMA transferred to the register group of the DMA controller 13B from the register data memory 36 of the companion chip 3.

First, the CPU 10 accomplishes register settings for the DMA controller 13C. The address of the register memory 36 of the companion chip 3 is set in the reading start address register 21 of the DMA controller 13C, the address of the register group of the DMA controller 13B is set in the writing start address register 22 and the byte count of the register group is set in the transfer count register 23.

Next, the CPU 10 outputs to the controller 33 of the companion chip 3 the vertical and horizontal byte count in the image information read from the ROM 11, and the position of rendering that image on the VRAM 15 (the writing start address on the VRAM 15). The controller 33 sets in the register data memory 36 the writing start address on the VRAM 15, the address of the buffer 30 and a byte count found by adding 1 byte to the byte count of the data sequence of one row (the transfer count).

The controller 33 outputs the control signal for starting DMA transfer to the controller 20 of the DMA controller 13C. Whereupon, the data contained in the register data memory 36 of the companion chip 3 is DMA transferred to the register group of the DMA controller 13B under control of the DMA controller 13C. As a result, the address of the buffer 34 of the companion chip 3 is set in the reading start address register 21 of the DMA controller 13B, the writing start address of the VRAM 15 is set in the writing start address register 22 and the byte count (transfer count) found by adding 1 byte to the byte count of the data sequence of each row of the image information is set in the transfer count register 23.

The controller 33 of the companion chip 3 determines whether or not writing of the data sequence of each row of image data to the VRAM 15 by the DMA controller 13B is concluded, based on the byte count found by adding 1 byte to the byte count of the data sequence of one row of image data read from the ROM 11. When it is determined that writing is concluded, the controller 33 sets the writing start address of the next row and the address of the same column in the region corresponding to the writing start address of the register data memory 36.

Next, the controller 33 outputs the control signal for DMA transfer start to the DMA controller 13C. Upon receiving this, the DMA controller 13C DMA transfers the data in the register data memory 36 to the DMA controller 13B. As a result, the address set in the writing start address register 22 of the DMA controller 13B is updated to the address of the same column as the writing start address in the next row. In data transfer starting with the next, data transfer to the VRAM 15 from the buffer 34 is started from the updated writing start address.

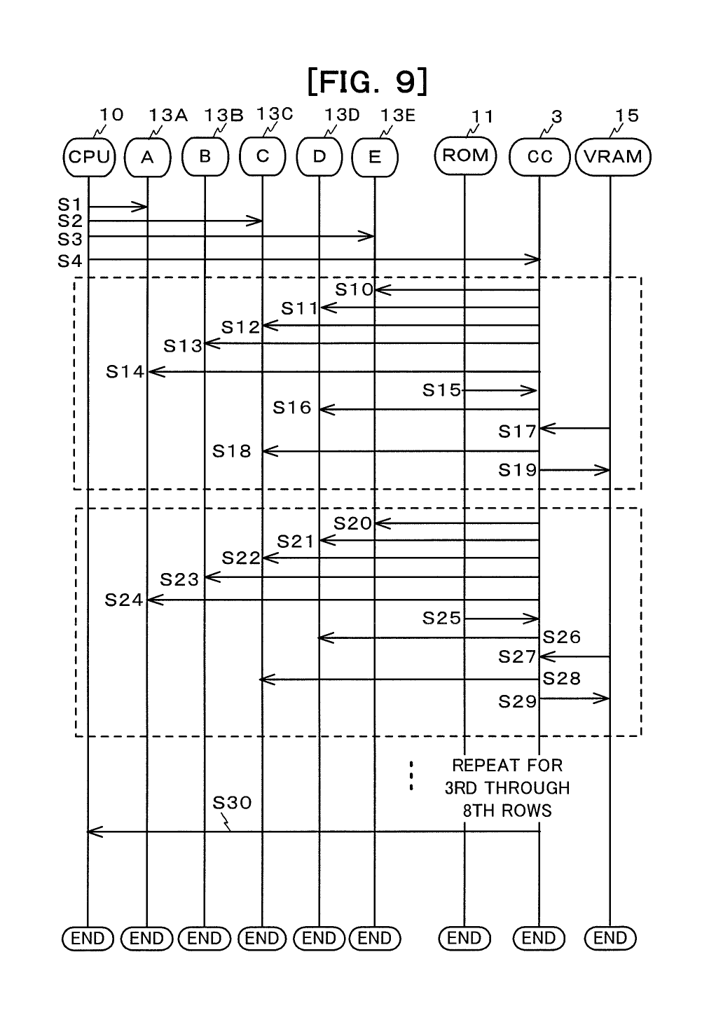

Next, the actions of the writing device 100 according to this preferred embodiment will be explained with reference to the sequence chart in FIG. 9.

FIG. 9 shows a process sequence when the image of a given character is displayed at a prescribed position on the display screen of the display device 2 by CPU 10. Here, the explanation will be for the case when image data of a character with a horizontal width of 8 bits is displayed on the display screen of the display device 2. In FIG. 9, A, B, C, D, and E respectively indicate the DMA controllers 13A, 13B, 13C, 13D and 13E. In addition, CC indicates the companion chip 3.

First, the CPU 10 accomplishes register setting of the DMA controller 13A (step S1). Through this, a condition in which DMA transfer from the ROM 11 to the buffer 30 of the companion chip 3 is possible is achieved.

Next, the CPU 10 accomplishes register setting of the DMA controller 13C (step S2). Through this, a condition in which DMA transfer to the register group of the DMA controller 13B from the register data memory 36 of the companion chip 3 is possible is achieved.

Next, the CPU 10 accomplishes register setting of the DMA controller 13E (step S3). Through this, a condition in which DMA transfer to the register group of the DMA controller 13D from the register data memory 35 of the companion chip 3 is possible is achieved.

Next, the CPU 10 sends to the controller 33 of the companion chip 3 a rendering command including the horizontal and vertical byte counts of the image data displayed, the writing start address of the VRAM 15 (the upper left address) and the shift number for shifting the image data (step S4).

Upon receiving this rendering command, the controller 33 of the companion chip 3 sets in the register data memory 36 the address of the buffer 34, the writing start address of the VRAM 15 and the transfer count (2 bytes).

Next, the companion chip 3 outputs a control signal to start DMA transfer to the DMA controller 13E (step S10). Through this, DMA transfer from the register data memory 35 of the companion chip 3 to the register group of the DMA controller 13D is accomplished (step S11). Through this, a DMA transfer from the VRAM 15 to the buffer 32 is possible.

Next, the companion chip 3 outputs a control signal to start DMA transfer to the DMA controller 13C (step S12). Through this, DMA transfer from the register data memory 36 of the companion chip 3 to the register group of the DMA controller 13B is accomplished (step S13). Through this, a DMA transfer from the VRAM 15 to the buffer 34 is possible.

Next, the companion chip 3 outputs a control signal to start DMA transfer to the DMA controller 13A (step S14). Through this, 1 byte of data at the start address of the image data in the ROM 11 is transferred to the buffer 30 of the companion chip 3 (step S15). Following this, in the companion chip 3 the data sequence read into the buffer 30 is stored in the shift operator 31, as shown in FIG. 8A, and is shifted by a shift number specified by the CPU 10.

Next, the companion chip 3 outputs a control signal to start DMA transfer to the DMA controller 13D (step S16). Through this, 2 bytes of data from the writing start address of the VRAM 15 are transferred to the buffer 32 of the companion chip 3 (step S17).

The data sequence shifted by the shift operator 31 and the data sequence read into the buffer 32 are input into the controller 33 and a logical operation is made, as shown in FIG. 8A. Through this logical operation, an integrated data sequence of the two data sequences is generated. This integrated data sequence is written to the buffer 34.

Next, the controller 33 of the companion chip 3 outputs a control signal to start DMA transfer to the DMA controller 13C (step S18). Whereupon, the 2-bytes data sequence written to the buffer 34 is transferred to the writing start address of the VRAM 15 (step S19)

The processes of these steps S10 through S19 are the writing process of the first row.

Upon detecting at this point in time that writing of the first row has concluded, the controller 33 accomplishes a writing process for the second row the same as the above-described writing process of the first row (steps S20 through S29). Furthermore, writing processes for the 3 through 8 rows are accomplished the same as the writing process for the second row.

When the writing process of the eighth row concludes, the controller 33 outputs a conclusion notification signal to the CPU 10 (step S30). Through this, image data of the character at an arbitrary position without 8-bit spacing is written to the VRAM 15 as shown in FIG. 8B, and the image (character B) based on that image data is displayed on the display screen of the display device 2. In addition, the images around the VRAM 15 are read and integrated with the character B and are then rewritten to the VRAM, so even when the character B is displayed, the images d already displayed on the two ends thereof are not erased.

As described in detailed above, with this preferred embodiment, it is possible to display image data of each row read from the ROM 11 shifted by an arbitrary bit number. Consequently, it is possible to cause images to be displayed based on image data at an arbitrary position. In addition, final image data is generated through a logical operation with image data read from the VRAM 15, so it is possible to prevent erasure of surrounding images already displayed. As a result, it is possible to improve freedom in displays on a full-dot liquid crystal display screen.

In this preferred embodiment, a rendering device 100 that accomplishes a process such that images already retained in the VRAM 15 are not erased by newly displayed images was explained. However, the operation process executed by the controller 33 is intended to be illustrative and not limiting, for applying various display effects to the displayed image is also possible.

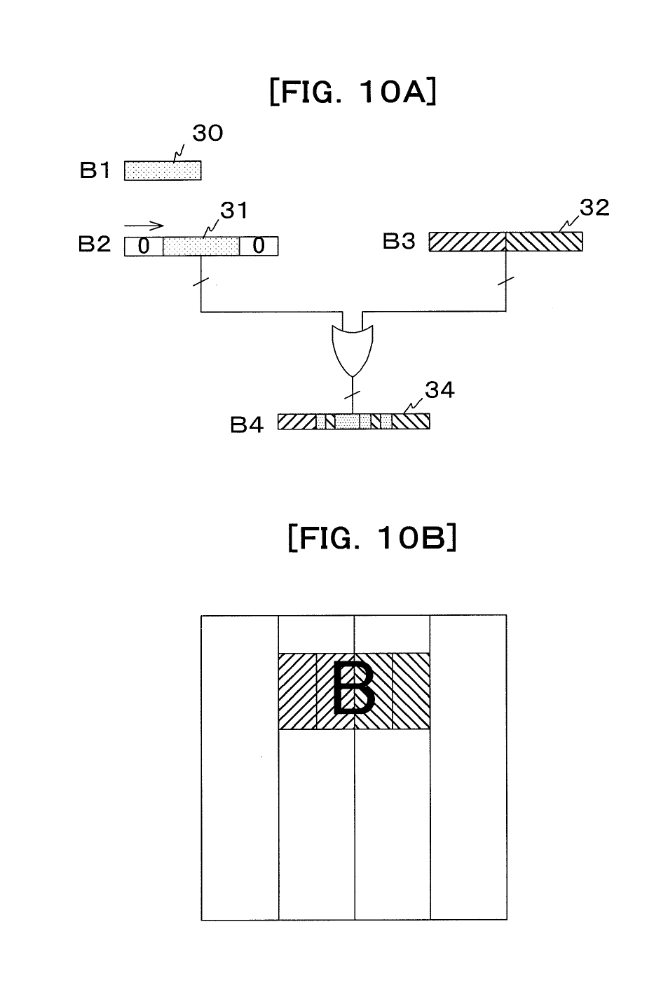

For example, as shown in FIG. 10A, it is possible to output to the buffer 34 a data sequence B4 obtained by finding the logical sum of the data sequence B2 whose displayed image data is shifted and the data sequence B3 read from the VRAM 15. The image displayed by the data sequence B4 obtained in this manner becomes an image through which images already retained in the VRAM 15 pass with respect to images read from the ROM 11, as shown in FIG. 10B.

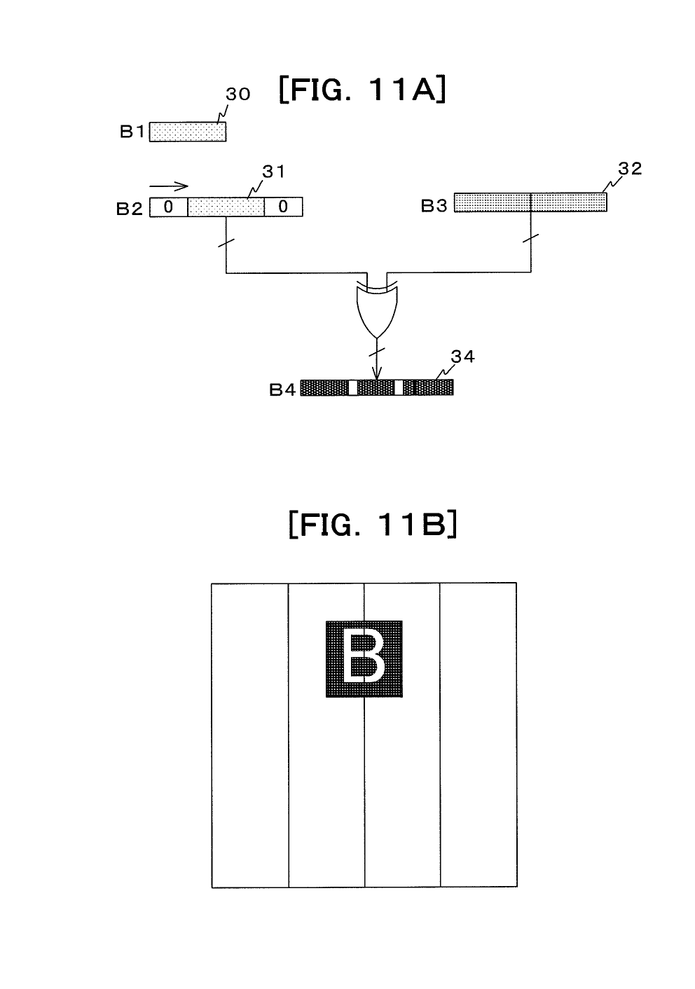

In addition, as shown in FIG. 11A, it is possible to output to the buffer 34 a data sequence B4 obtained by performing an exclusive OR operation on the data sequence B2 whose displayed image data is shifted and the data sequence B3 read from the VRAM 15. The image displayed by the data sequence B4 obtained in this manner becomes a reverse image of the image generated by the image already retained in the VRAM 15 and the image read from the ROM 11, as shown in FIG. 11B.

In the controller 33, it is preferable to be able to select one of the above-described three display effects based on settings.

In this preferred embodiment, the horizontal size of the image data was taken to be 1 byte, but it is possible for the present invention to be applied to image data having a size of 2 or more bytes as well.

The transfer source to the buffer 30 need not be the ROM 11 but may be the RAM 12.

The rendering device 100 according to the above-described preferred embodiments was a remote controller for an air conditioning device, but it is possible for this to be a remote controller for a lighting device or some other electrical equipment.

Having described and illustrated the principles of this application by reference to one preferred embodiment, it should be apparent that the preferred embodiment may be modified in arrangement and detail without departing from the principles disclosed herein and that it is intended that the application be construed as including all such modifications and variations insofar as they come within the spirit and scope of the subject matter disclosed herein.

This application claims the benefit of Japanese Patent Application 2010-245707, filed Nov. 1, 2010. The entire specification, scope of claims, and renderings of the Japanese Patent Application No. 2010-245707 are incorporated herein by reference.

### INDUSTRIAL APPLICABILITY

The present invention is applicable to a remote controller for electrical equipment such as an air conditioning device or a lighting device.

### REFERENCE SIGNS LIST

1 Microcomputer
2 Display device
3 Companion chip (CC)
4 Image data
10 CPU
11 ROM
12 RAM
13A, 13B, 13C, 13D, 13E DMA controller
14 External interface (I/F)
15 VRAM
16 Operation input interface (I/F)
17 Bus
20 Controller
21 Reading start address register
22 Writing start address register
23 Transfer count register
30 Buffer
31 Shift operator
32 Buffer
33 Controller
34 Buffer
35, 36 Register data memory (RDM)
100 Rendering device
P Position

1. A rendering device for reading in address units image information stored in a memory medium in which each row of a data sequence is linked in sequential order, and displaying an image based on this image information by writing in a prescribed region of a two-dimensional image display memory, this rendering device comprising:
a first reader for reading the image information stored in the memory medium in address units from a reading start address that is the lead thereof;
a shift operator for generating a second data sequence by shifting a first data sequence that is one row of data in the image information read by the first reader by a specified number of bits;
a second reader for reading a third data sequence already stored at a writing start position of the image display memory;
an operator for generating a fourth data sequence by performing a prescribed operation using the second data sequence shifted by the shift operator and the third data sequence read by the second reader;
a writer for successively writing the fourth data sequence generated by the operator in a horizontal direction in the address units beginning from the writing start position of the image display memory; and
a writing position updater for updating the writing start position in the image display memory to a position in the same column of the next row each time writing of each row of the data sequence by the writer concludes.

2. The rendering device according to claim 1, wherein the operator:
generates a fifth data sequence by clearing to zero the value of the part in the third data sequence overlapping the first data sequence; and
generates as the fourth data sequence a data sequence obtained by taking the logical sum of the second data sequence and the fifth data sequence.

3. The rendering device according to claim 1, wherein the operator generates as the fourth data sequence a data sequence obtained by taking the logical sum of the second data sequence and the third data sequence.

4. The rendering device according to claim 1, wherein the operator generates as the fourth data sequence a data sequence obtained by performing an exclusive OR operation on the second data sequence and the third data sequence.

5. A rendering method for reading in address units image information stored in a memory medium in which each row of a data sequence is linked in sequential order, and displaying an image based on this image information by writing in a prescribed region of a two-dimensional image display memory, this method comprising:
reading the image information stored in the memory medium in address units from a reading start address that is the lead thereof;
generating a second data sequence by shifting a first data sequence that is one row of data in the image information read by a specified number of bits;
reading a third data sequence already stored at a writing start position of the image display memory;
generating a fourth data sequence by performing a prescribed operation using the second data sequence shifted and the third data sequence read;
successively writing the fourth data sequence generated in a horizontal direction in the address units beginning from the writing start position of the image display memory; and
updating the writing start position in the image display memory to a position in the same column of the next row each time writing of each row of the data sequence concludes.

6. The rendering device according to claim 1, wherein
the memory medium and the image display memory are provided in a microcomputer,
the first reader, the second reader, and the writer are provided in the microcomputer, and
the shift operator, the operator, and the writing position updater are provided for an external device connected with the microcomputer.

7. The rendering device according to claim 6, wherein
the first reader is a first DMA controller that executes a DMA transfer from the memory medium to the external device,
the second reader is a second DMA controller that executes a DMA transfer from the image display memory to the external device, and
the writer is a third DMA controller that executes a DMA transfer from the external device to the image display memory.

8. The rendering device according to claim 7, wherein
the microcomputer further includes
a fourth DMA controller that executes a DMA transfer from the external device to a register of the second DMA controller, and
a fifth DMA controller that executes a DMA transfer from the external device to a register of the third DMA controller, and
the writing position updater updates the writing start position in the image display memory to a position in the same column of the next row, through updating the registers of the second and third DMA controllers using the fourth and fifth DMA controllers.

9. A non-transitory computer-readable recording medium storing a program for a computer that controls a rendering device for reading in address units image information stored in a memory medium in which each row of a data sequence is linked in sequential order, and displaying an image based on this image information by writing in a prescribed region of a two-dimensional image display memory, the program allowing the computer to function as:
a first reader reading the image information stored in the memory medium in address units from a reading start address that is the lead thereof;
a shift operator generating a second data sequence by shifting a first data sequence that is one row of data in the image information read by the first reader by a specified number of bits;
a second reader reading a third data sequence already stored at a writing start position of the image display memory;
an operator for generating a fourth data sequence by performing a prescribed operation using the second data sequence shifted by the shift operator and the third data sequence read by the second reader;
a writer successively writing the fourth data sequence generated by the operator in a horizontal direction in the address units beginning from the writing start position of the image display memory; and
a writing position updater updating the writing start position in the image display memory to a position in the same column of the next row each time writing of each row of the data sequence by the writer concludes.
